(19) United States
(12) Patent Application Publication
(10) Pub. No.: US 2004/0022391 A1
(43) Pub. Date: Feb. 5, 2004

(54) Digital content security system and method

(76) Inventor: Royal O'Brien, Jacksonville, FL (US)

Correspondence Address: Mark J. Young, McGuireWoods LLP, Suite 3300, 50 North Laura Street, Jacksonville, FL, 32202, US

(21) Appl. No.: 10/631,406

(22) Filed: Jul. 30, 2003

Related U.S. Application Data
(60) Provisional application No. 60/399,846, filed on Jul. 30, 2002.

(51) Int. Cl. H04L 9/00

(52) U.S. Cl. 380/281; 380/284

(57) ABSTRACT

A digital content security system and method encrypts a key required for playback of digital content, fragments the encrypted key and embeds the fragments in portions of a payload; encrypts determined portions of frames of the digital content, and uses the decrypted key to decrypt the encrypted portions for playback in real-time; and requires an active authenticated session to access the encrypted key, decrypt it, access the encrypted portions and decrypt them.

### PROVISIONAL APPLICATION

This application claims priority to U.S. Provisional Application 60/399,846, filed Jul. 30, 2002, the entire contents of which are hereby incorporated by reference herein.

### FIELD OF THE INVENTION

This invention relates generally to data security, and more particularly to an end-to-end system and method for secure delivery and playback of multimedia data.

### BACKGROUND

Intellectual property rights management is critical to the successful deployment of Video on Demand (VOD) and Download and Store (D&S) systems. Copyright owners demand that their content be distributed in a secure manner such that only authorized parties have access to the content, only on authorized equipment, typically only for an authorized time period (e.g., 1 viewing or X hours), and only for authorized viewing (i.e., not reproduction or distribution). Concomitantly, the security system should not compromise playback, such as by introducing material delays, create unreasonable complications for the end-user, or result in increased cost, such as by requiring new hardware. Achieving these objectives for VOD, D&S and related systems requires encryption and authentication.

### SUMMARY

It is therefore an object of the present invention to provide a digital data security system that enables efficient encryption and decryption.

It is another object of the present invention to provide a digital data security system that enables user authentication and playback equipment authentication.

It is also another object of the invention to provide a digital data security system that is suitable for implementation with Video On Demand, Download and Store (video and/or music), Video Conferencing and

Streaming Music Systems.

It is yet another object of the invention to provide a digital data security system that encrypts a key required for playback, fragments the encrypted key and embeds the fragments in portions of the payload.

It is a further object of the invention to provide a digital data security system that requires an online session using authenticated ports to decrypt and play downloaded data.

To achieve these and other objects, an exemplary methodology is provided that encrypts a key required for playback of digital content, fragments the encrypted key and embeds the fragments in portions of a payload; encrypts determined portions of frames of the digital content, and uses the decrypted key to decrypt the encrypted portions for playback in real-time; and requires an active authenticated session to access the encrypted key, decrypt it, access the encrypted portions and decrypt them. Applying dynamic layers of authentication, key encryption and data encryption, the exemplary methodology achieves a high level of security.

### BRIEF DESCRIPTION OF THE DRAWINGS

The foregoing and other objects, features and advantages of the present invention will become better understood with reference to the following description and accompanying drawings, where:

FIG. 1 conceptually depicts an exemplary sign-up process in accordance with a preferred implementation of the present invention;

FIG. 2 conceptually depicts an exemplary player software download process in accordance with a preferred implementation of the present invention;

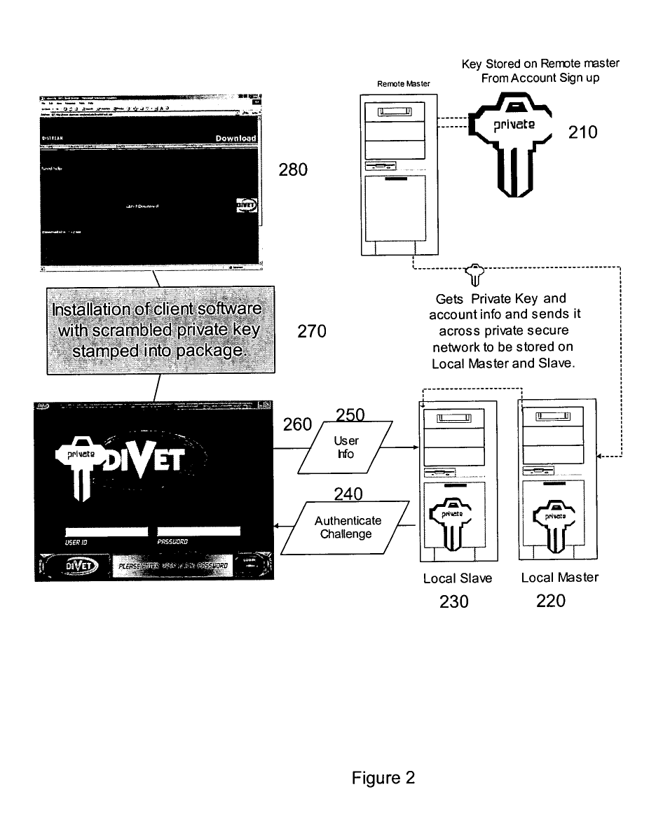

FIG. 3 conceptually depicts a working session initiation process in accordance with a preferred implementation of the present invention;

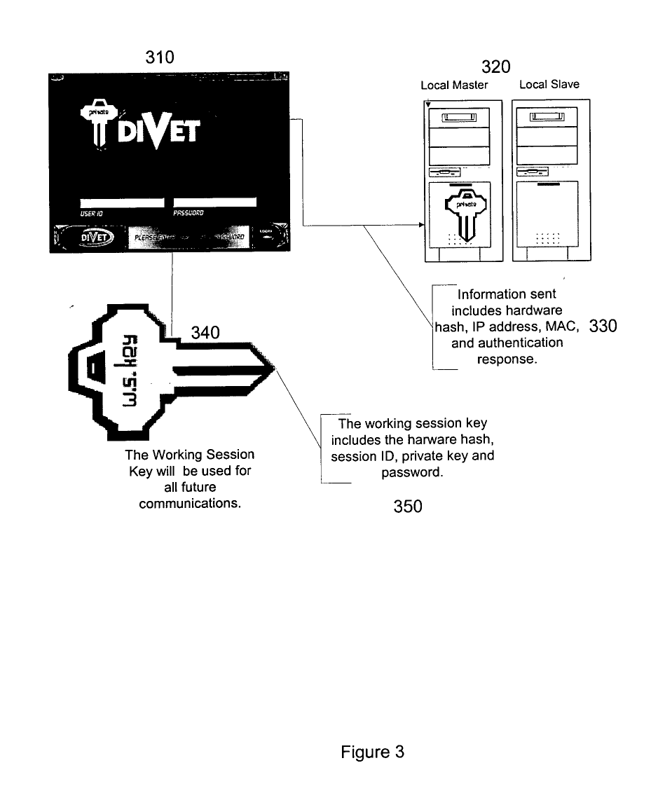

FIG. 4 conceptually depicts a movie database update process in accordance with a preferred implementation of the present invention;

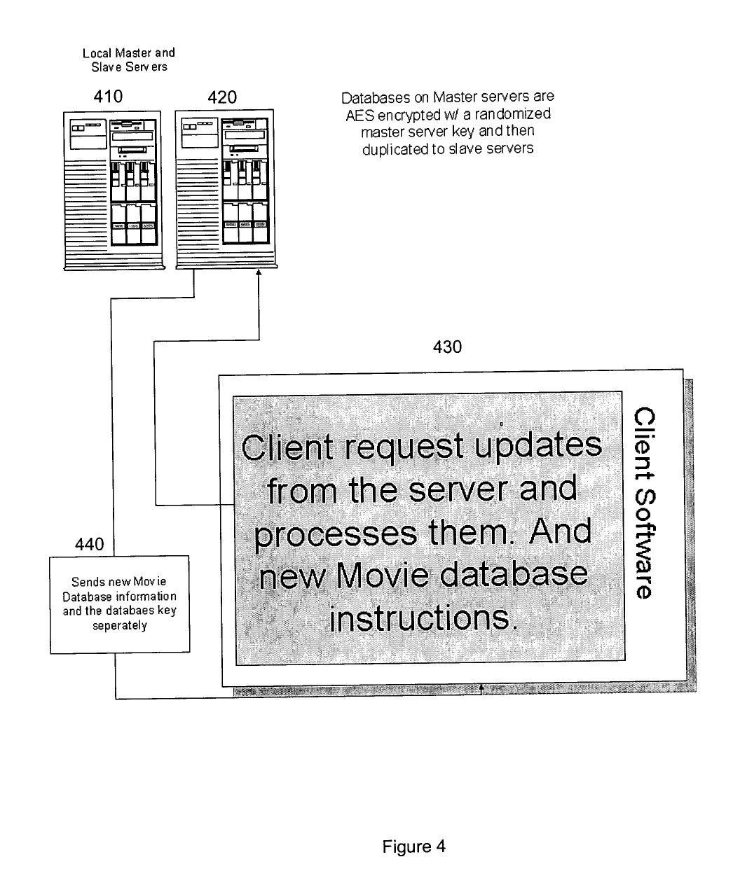

FIG. 5 conceptually depicts a transaction request process in accordance with a preferred implementation of the present invention;

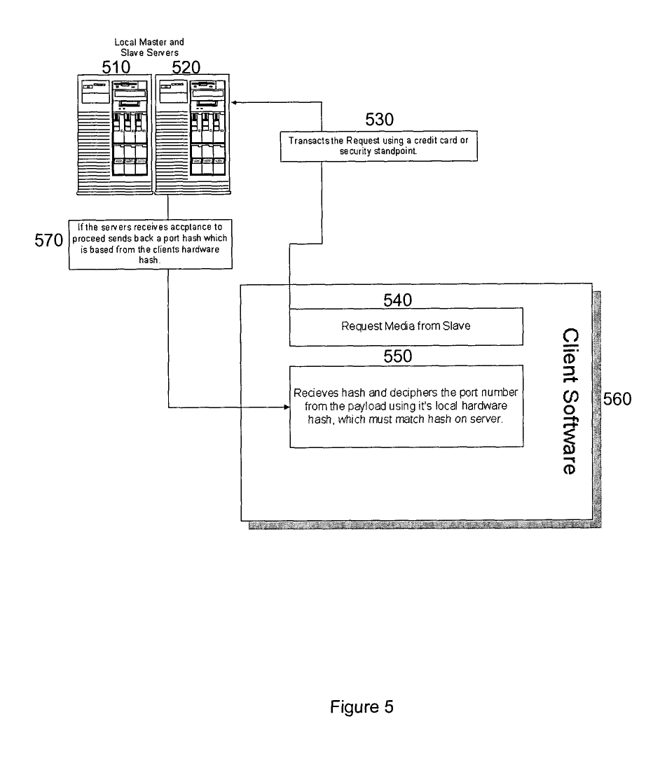

FIG. 6 conceptually depicts a key fragmentation process in accordance with a preferred implementation of the present invention;

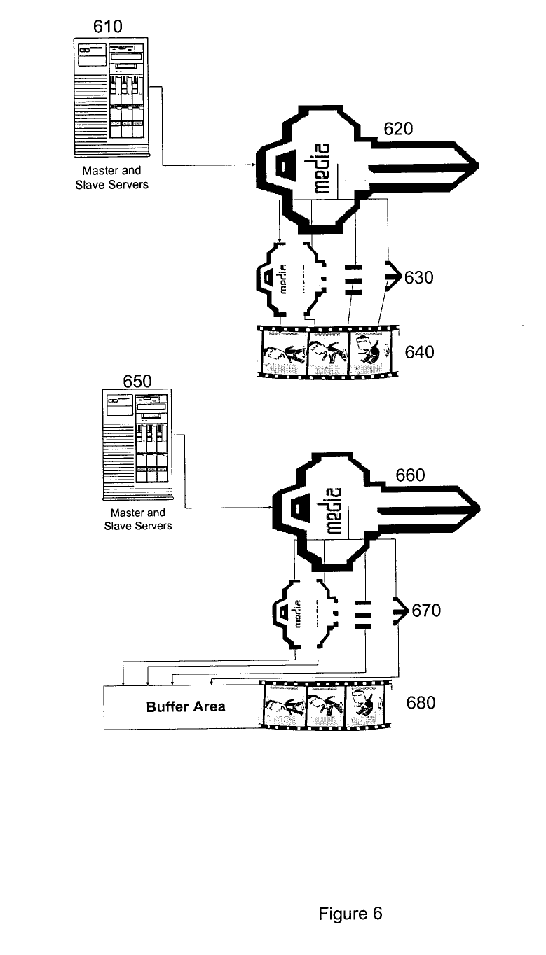

FIG. 7 conceptually depicts a playback authentication process in accordance with a preferred implementation of the present invention; and

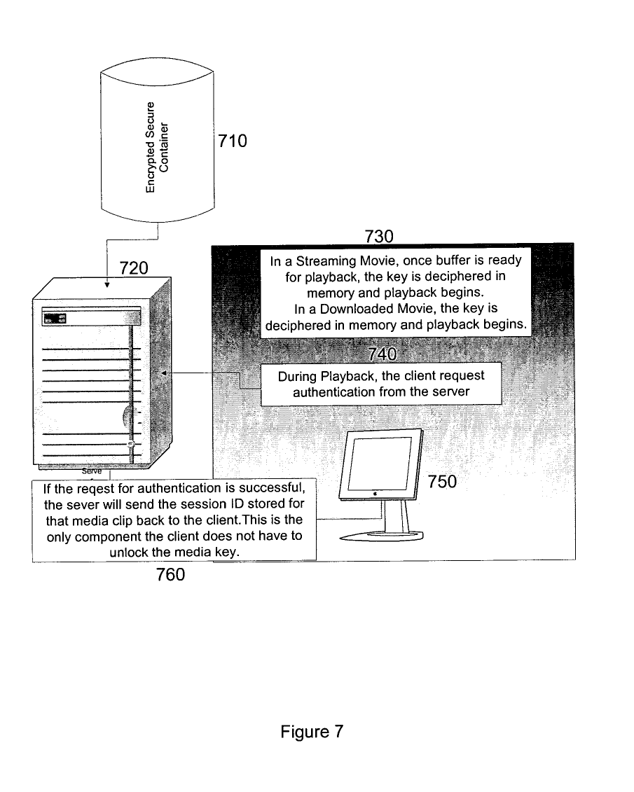

FIG. 8 conceptually depicts a decryption process in accordance with a preferred implementation of the present invention.

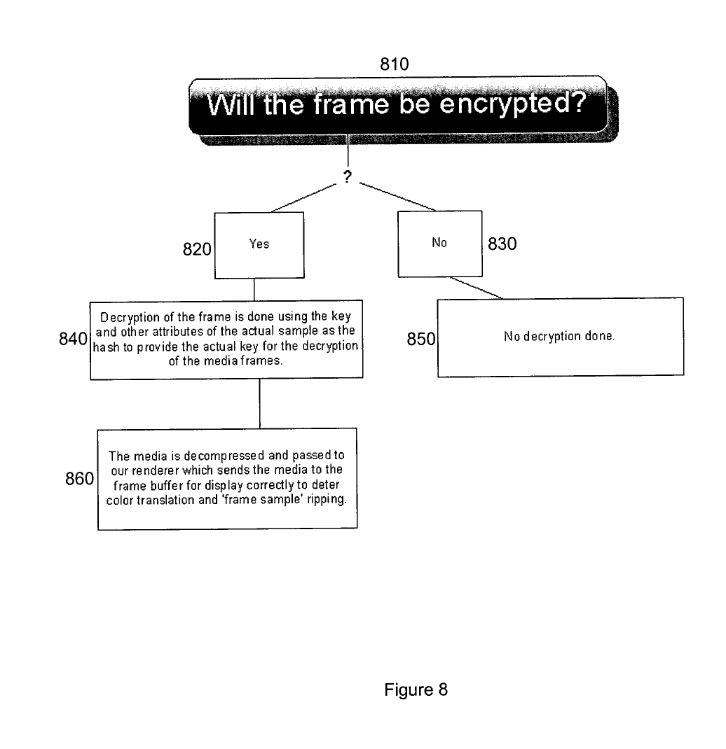

### DETAILED DESCRIPTION

A methodology in accordance with an exemplary embodiment of the present invention may include several processes (as referenced in the brief description of the drawings and the following detailed description) in combination to provide an end-to-end solution. Alternatively, a process (such as the encrypted key fragmentation and embedding process) may be used individually, apart from the other processes described below, and come within the scope of the present invention.

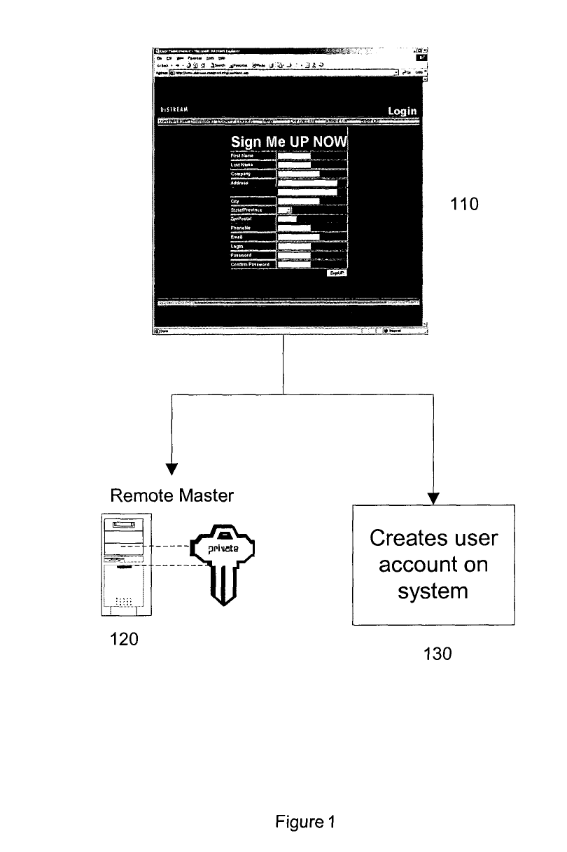

An exemplary setup process entails establishing an account and obtaining necessary software, such as a player. To access a video distribution system in accordance with a preferred implementation of the present invention, a new user may visit a web site and sign-up for a new account. Referring to FIG. 1, the user may provide a name, address and other relevant information 110. To establish the account, the user may be asked to create a user ID (Login) and password. When the user finishes creating the account, a unique private key 120 associated with the new user, the account key, may be stored on a database resident at a remote master server.

Alternative methods for account setup include telephonic, with or without the assistance of a customer service representative, and conventional account establishment means known in the art. For example, an account may be established by dialing a number and entering data telephonically to a server having a telephony application program interface (TAPI), or by other data entry methods known in the art.

In addition to setting-up an account, a new user preferably downloads and installs on her equipment, such as a PC (i.e., the client), certain software such as a video player software application (i.e., player software). The newly registered user may log into the web site 260 to download the player software. Upon logging in, the account key is retrieved from the remote master server 210. The client installs the player software across the Internet 270 and 280 and the player software package is stamped with (i.e., associated with) a scrambled version of the account key.

Alternatively, a copy of the player software may be recorded on a medium, such as a diskette, CD-ROM or hardware (e.g., firmware, a set-top box, or ROM) and provided to a user. The player software as provided on such a medium may either be pre-configured with a stamped scrambled version of the account key or require the user to download and install it. The player software may also be downloaded while the digital content is downloaded as an integral part of the digital content payload or as a separate payload sent before, during or after the digital content payload.

The player software preferably incorporates security features to prevent tampering with its functionality. The player may be broken into components, and as the components are combined, a decryptor may check the integrity of each component by byte signature and 32 bit CRC checks. In addition, during playback, if any component fails, the decryptor will render no input or output pins, and will attempt to unload itself. This prevents the media stream from being decrypted by a tampered player.

During use, the player software may send information to a server and receive information from the server to verify and authenticate information pertaining to the user, player software, equipment and/or session. For example, the player software may scramble and send to a local server a small portion of the user information, such as the User ID 250. The server may unscramble the user information and use it to retrieve the account key from the remote master server 210 and copy the user account information to the local master 220 and slave 230 servers for caching. The slave server 230 may then send an AES encrypted authentication challenge 240 to the client, along with additional connection information. The client may deploy its locally stamped account key to decipher the authentication challenge and the connection information. The connection information may be used by the client to create a new private key, the connection key (connection information+user's private key [i.e., account key]), which may be used to encrypt computer-specific information along with the authentication response.

The preferred Advanced Encryption Standard (AES) specifies a Federal Information Processing Standards-approved symmetric block cipher that can be used to encrypt and decrypt electronic data. AES is capable of using cryptographic keys of 128, 192 and 256 bits to encrypt and decrypt data in blocks of 128 bits. Those skilled in the art will appreciate that other encryption methodologies, whether proprietary or not and whether adopted as an industry or government standard or not, may be used in lieu of AES without departing from the scope of the present invention.

The server may then decrypt the message and read the response. If the server can read the response, it may log the IP and hardware hash to the account and grant access by response with the final key used with AES encryption on the payload.

In addition to performing authentication steps prior to use of the player software for downloading and playing content, the client (via the player software) may create a unique private working session key that may be unlocked using a hash comprised of computer specific information, connection information and the account key 330, 350. Both the client and server know each of these locally. This working session key 340 may used for all future communications during the current active session, including user login. The user may be authenticated via her User ID and password 310. The user's login password may be transmitted to the server encrypted using the working session key.

The client may then request updates (e.g., an updated database of available movies) from the server and process them as well as commands to remove expired media and update the local databases 430.

The databases are preferably AES encrypted on the master server with a randomized master server key and then duplicated to the slave servers 410 and 420. When the client requests the databases, it receives the encrypted database and the key for the database separately 440. The database key may be encrypted with the working session key, and sent to the client to decrypt the database locally.

A user's request to download or stream media 540 may be relayed from the web site server to the slave servers 510 and 520. The slave servers may process the request by interfacing with credit card authorization systems and by checking any security policies 530.

If the delivery of the media (i.e., digital content) is authorized, the slave server may dynamically select a connection port for future communications and calculate a server port hash value 570. The server may then transmit to the client connection information based on the client's computer specific information and server side port hash values 550. The server preferably assigns ports dynamically, because standard static ports are much easier to trace. The client may then decipher the actual port number from the payload using its computer specific information 550. A copy of the connection specific information can be stored in the account for the specific media file on the server.

When a first packet is sent, preferably the server will wait a determined amount of time (e.g., a maximum of 2000 ms) for an acknowledgement from the client. If one is not received, then the server may issue a new session ID and instruct the client to renegotiate the port and packet again. This deters freezing the system (i.e., “ice capping”) and attempts to decipher the byte flow.

The key for the actual media 620, 660 may be encrypted with the working key, scrambled in a determined fashion and then sent. A copy of the session ID is stored in the account for the media file on the server. The key may be broken up into fragments 630, 670, which are preferably embedded and transferred in portions of the payload in a download and store implementation. The fragments may be of equal or unequal sizes. They may be embedded in the payload in order (least significant to most significant bit or vice versa) or out of order. The fragments may be separated according to a determined algorithm, which may embed each fragment at a location determined relative to a location for a preceding fragment (if any). The algorithm may be based upon formulae, packet information, session information, media data, client information, user information and/or any combination of the foregoing. The algorithm may be hard-coded into the player software, or variable, in whole or in part, periodically, as a rule defined by a server. If variable, the algorithm may change from time to time during a session, after each n^{th} session, after a random interval and/or upon management directive. If downloaded, the algorithm would preferably be provided during a secure authenticated session in an encrypted form, perhaps as part of the payload. In a streaming mode, the fragments may be embedded within buffered frames (e.g., approximately 90 frames for a 3 second buffer) 680. These several variables (i.e., frames containing fragments, fragment size, fragment location, fragment order, and fragment encryption) substantially reduce the risk of successful hacking. Only by obtaining all frames containing all encrypted fragments, determining the location and size of each fragment, reconstructing the encrypted key based on a proper ordering of the fragments, and decrypting the reconstructed key, would security potentially be compromised.

The client will receive the media stream, extract the fragments of the media key, segment by segment, from the payload, and either reconstruct the encrypted key and place it into an encrypted secure container 710 (e.g., an encrypted temporary file or sector) or place the fragments into the encrypted secure container 710. The media key may remain in encrypted form (and possibly in a fragmented form) within the secure container.

In a streaming mode (e.g., VOD), once the buffer is ready for playback, the media key may be deciphered in volatile memory (or in non-volatile memory) and playback begins 730. The media key can be kept scrambled in memory except when it is actively being used by the “decryptor”. When not in active use, the media key may be rescrambled using a new value.

In a download and store mode, upon user request for playback, the client may request authentication from the server 740. If successful, the server will send the connection specific information (e.g., session ID) stored for that media file to the client 750 using AES encryption with the working session key 760. The connection specific information is the only component that is not present in the encrypted secure container but which is necessary to unlock the media key. As a result, the hardware information from time of download to time of playback must stay the same.

Decryption of the media file may be performed during playback. The process begins by querying attributes of each video and time frame to determine the type of decryption (if any) that needs to be applied 810-830. If a frame is not encrypted, decryption is not performed 850. The “decryption key” used for decryption of the actual media values in each block of data is extracted through several decryption iterations that start with decryption of the media key and other attributes of the media 840.

All server-side keys are preferably scrambled by algorithms that use 512-bit keys, and are securely stored at the video storage site. In addition, 128/192/256-bit AES encryption is applied to the video payload itself. The video payload decryption key, which may be dynamically created at the video server and fragmented and embedded throughout the actual video payload moments before downloading or streaming begins as described above, is preferably unique for each particular user session and media content.

Initial encryption of the media content is performed during the encoding process. The encryption key is dependent on the media itself and the selection of media samples (e.g., frames or portions thereof) to be encrypted may be dictated by a determined cryptographic formula 840. Several layers of encryption are applied as the encrypted media content is packaged for delivery to the user. These layers involve encryption of the decryption keys prior to transmission to the client and, of course, encryption of the video payload itself.

In a preferred implementation, portions of determined frames are encrypted. The portions may be from one byte to an entire frame. Each frame may include from zero to a plurality of encrypted portions. The location of an encrypted portion within a frame may be determined according to an algorithm (i.e., a determined cryptographic formula). Such an algorithm may be based upon formulae, random data, packet information, session information, media data, client information, user information and/or a combination of the foregoing. The algorithm may be hard-coded into the player software, or downloaded (in an encrypted format), in whole or in part, periodically or with each session as a rule defined by the server. Only by determining which frames contain one or more encrypted portions, determining the number of encrypted portions in each such frame, determining the location and size of each encrypted portion within each such frame, and then decrypting the portions, would security potentially be compromised. Those skilled in the art will appreciate that the last step (i.e., decrypting the portions) will preferably require an active authenticated session and decryption of the reconstructed key as described above, thus combining additional layers of security.

In the Download and Store and streaming modes, the system may require the client to be connected to the server throughout the entire playback (for example, the entire movie) for successful playback of the content resident on the client's disk (Download and Store mode) or being streamed and buffered (streaming mode). If the connection is lost, or deliberately broken, the player software preferably re-negotiates the session, re-authenticates and continues viewing. If re-authentication is not accomplished after a predetermined time, the player software preferably halts playback. Alternatively, or in addition to the foregoing, a presentation (temporal) stamp can be embedded in the cipher, thereby allowing viewing of downloaded video after an initial authentication, with or without the need to remain connected to the system throughout the length of the movie, for a limited time. Upon expiration of the time stamp (a given number of hours or days), video decryption and playback will cease.

To protect content further, the system preferably decrypts content only for authorized playback. Storage of encrypted content may only be allowed in the Download and Store mode. Stored content may be deleted from the client during the next connection to the server by overwriting a zeroed file to the same location and then deleting the file. In the VOD Streaming mode, preferably no content is stored except for in the frame buffer. Even if encrypted content is somehow extracted from the client playback, unauthorized decryption may not be feasible because encryption is a dynamic process requiring cooperation between server and client.

The player preferably decrypts the media (i.e., digital content), decompresses (i.e., decodes) it and passes it directly to a renderer 860, which may send the media directly to the frame buffer, thereby deterring ‘frame sample’ ripping. This also allows for a high quality image by eliminating color translation.

Those skilled in the art will appreciate that the exemplary methodology was designed to discourage attacks by sophisticated amateur hackers and to make it difficult and expensive for professional hackers to break the security of the system and extract a clean video payload. Concomitantly, the exemplary encryption methodology was designed to minimize the processing and latency overheads frequently associated with encryption technologies, making the system scalable and providing a pleasant user experience by eliminating unnecessary delays in the playback of the media content.

While the invention has been described in terms of its preferred embodiments, those skilled in the art will recognize that the invention can be practiced with modifications within the spirit and scope of the foregoing detailed description. Such alternative embodiments and implementations are intended to come within the scope of the present invention.

Having thus described the present invention, what is claimed as new and desired to be secured by Letters Patent is as follows:

1. A digital content security method comprising steps of encrypting a portion of a digital content payload, encrypting a first key required for decryption of the digital content payload, fragmenting the encrypted first key into a plurality of encrypted first key fragments, and embedding the encrypted first key fragments in determined locations of the payload.

2. A digital content security method according to claim 1, further comprising a step of providing a second key for decrypting the encrypted first key.

3. A digital content security method according to claim 2, further comprising dynamically assigning a port for a session.

4. A digital content security method according to claim 3, further comprising a step of providing a third key.

5. A digital content security method according to claim 4, wherein the second key, as provided, is encrypted using the third key.

6. A digital content security method according to claim 5, wherein the portion of the digital content payload that is encrypted is comprised of determined frames that comprise portions of the digital content payload.

7. A digital content security method according to claim 5, wherein the portion of the digital content payload that is encrypted is comprised of determined frames that comprise portions of the digital content payload.

8. A digital content security method according to claim 5, wherein the portion of the digital content payload that is encrypted is comprised of determined portions of determined frames that comprise portions of the digital content payload.

9. A digital content security method according to claim 8, wherein the determined frames and the determined portions of the determined frames are determined according to a determination means comprised of means from the group consisting of:
a formula,
random data,
packet information,
session information,
media data,
client information, and
user information.

10. A digital content security method according to claim 8, wherein the determined portions of determined frames are one determined portion per determined frame.

11. A digital content security method comprising steps of encrypting a portion of a digital content payload, encrypting a first key required for decryption of the digital content payload, fragmenting the encrypted first key into a plurality of encrypted first key fragments, embedding the encrypted first key fragments in determined locations of the payload, and communicating the payload with the encrypted portions and the encrypted first key fragments in determined locations from a computer server to a client computer.

12. A digital content security method according to claim 11, further comprising a step of providing a second key for decrypting the encrypted first key.

13. A digital content security method according to claim 12, further comprising dynamically assigning a port for communication of the payload with the encrypted portions and the encrypted first key fragments in determined locations from a computer server to a client computer.

14. A digital content security method according to claim 13, further comprising a step of providing a third key.

15. A digital content security method according to claim 14, wherein the second key, as provided, is encrypted using the third key.

16. A digital content security method according to claim 15, wherein the portion of the digital content payload that is encrypted is comprised of determined frames that comprise portions of the digital content payload.

17. A digital content security method according to claim 15, wherein the portion of the digital content payload that is encrypted is comprised of determined frames that comprise portions of the digital content payload.

18. A digital content security method according to claim 15, wherein the portion of the digital content payload that is encrypted is comprised of determined portions of determined frames that comprise portions of the digital content payload.

19. A digital content security method according to claim 18, wherein the determined frames and the determined portions of the determined frames are determined according to a determination means comprised of means from the group consisting of:
a formula,
random data,
packet information,
session information,
media data,
client information, and
user information.

20. A digital content security method according to claim 18, further comprising a step of authenticating a communication session between the computer server and the client computer, monitoring status of the session and disabling access to the first key, second key or third key if the session becomes inactive or unauthenticated.
